(19) United States
(12) Patent Application Publication
(10) Pub. No.: US 2024/0012488 A1
(43) Pub. Date: Jan. 11, 2024

(54) SPRING MOUNT KEYBOARD

(71) Applicant: Shenzhen Yinchen Technology Co., Ltd, Shenzhen (CN)

(72) Inventor: Pengfei WU, Shenzhen (CN)

(21) Appl. No.: 18/106,651

(22) Filed: Feb. 7, 2023

(30) Foreign Application Priority Data
Jul. 11, 2022 (CN) 202221786946.1

(51) Int. Cl. G06F 3/02

(52) U.S. Cl. CPC G06F 3/0202

(57) ABSTRACT

Disclosed is a spring mount keyboard which comprises an outer shell, a mounting plate for switches is arranged at an upper position inside the outer shell, and a plurality of positioning columns are arranged in a lower position inside the outer shell. The positioning post has a spring mounted, and a press pin connected to a top of the spring. The press pin comprises a flat plate in a middle position, the flat plate has an upper boss protruding upwards arranged above, and a lower boss protruding downwards arranged below. An upper end of the spring sleeved outside the lower boss and the end of the spring abuts a lower surface of the flat plate. In the present application, the typing experience and sound feedback of each button of the keyboard are consistent.

### CROSS-REFERENCES TO RELATED APPLICATIONS

This application claims the priority of Chinese patent application no. 202221786946.1, filed on Jul. 11, 2022, the entire contents of all of which are incorporated herein by reference.

### FIELD OF THE APPLICATION

The present application relates to the technical field of keyboard design, in particular to a spring mount keyboard.

### BACKGROUND

Keyboard is an instruction and data input device to operate an equipment, which also refers to a group of function keys to operate a machine or an equipment through a system arrangement (such as a typewriter or a computer keyboard). Following a gradual improvement of people's life level in recent years, the requirement on the keyboards has also improved gradually. From the current keyboard market, keyboards are divided into membrane keyboards and mechanical keyboards according to their structures. The mechanical keyboard is favored by game players and IT employees because of its special typing experience which are more suitable for game entertainment or text input.

In the prior art, a mounting plate in existing mechanical keyboard adopts a structure connected fixedly to its shell. As a result, in the process of pressing the key, there will be inconsistent forces applied on the mechanical switches between different keys which shall affect typing experience and the consistency of sound feedback.

Therefore, the current technology needs to be improved and developed.

### BRIEF SUMMARY OF THE DISCLOSURE

The present application proposes a spring mount keyboard to solve the problem of inconsistent typing feelings and sound feedback caused by uneven keystroke forces applied on mechanical switches mentioned in the “BACKGROUND”.

The technical solution of the present application to solve the technical problems is as follows:
A spring mount keyboard is provided, which comprises an outer shell, a mounting plate configured to mount switches is arranged at an upper position inside the outer shell, and a plurality of positioning standoffs are arranged at a lower position inside the outer shell; a spring is arranged on the positioning standoffs; a press pin is connected to an upper position of the spring, comprising a flat plate arranged at a center of the press pin, an upper protrusion upwards is arranged above the flat plate, and a lower protrusion downwards is arranged below the flat plate; an upper part of the spring is arranged to sheath an outside of the lower protrusion, and an end of the spring abuts against a lower surface of the flat plate; the upper protrusion is positioned at a through hole arranged in a surface of the mounting plate.

Further, an upper cover plate with a hollowed-out structure is arranged above the outer shell, and a sealing gasket is arranged at a joint between the outer shell and the upper cover plate.

Further, a gap is arranged between the upper cover plate and the mounting plate, and a plurality of silica gel pads is arranged in the gap.

Further, a key cap is arranged above the switch.

Further, a positioning plate, a partition plate, and a PCB are arranged below the mounting plate sequentially, while the mounting plate, the positioning plate, the partition plate, and the PCB are connected through a plurality of bolts.

Further, at least two guiding rods are arranged vertically installed at a bottom position of the outer shell, the guiding rods are connected to the outer shell in a thread, and the guiding rods are connected slidably with the mounting plate, the positioning plate, the partition plate, and the PCB.

Further, a groove is arranged in an edge position of the mounting plate, the positioning plate, and the PCB.

Further, a polyester film and a rubber plate are arranged sequentially above a bottom wall of the outer shell.

Further, a back plate is installed on a bottom surface of the outer shell, and a plurality of anti-skid strips are arranged at an edge position of the bottom surface of the outer shell.

By adopting the technical scheme stated above, the beneficial effects of the present application are:
the present application uses the spring to balance and support keyboard modules, to achieve the effect of a large-stroke overall elasticity of the keyboard module. During the process of key pressing, mechanical switches on the mounting plate can be stressed as consistent as possible, to ensure the typing experience and the consistency of sound feedback of each button on the keyboard.

### BRIEF DESCRIPTION OF THE DRAWINGS

In order to illustrate the embodiments of the present application, a plurality of accompanying drawings, which are required to be used in the embodiments, are briefly described below. Obviously, the drawings in the following description are merely some embodiments of the present application. For those skilled in the art, a plurality of other drawings can be obtained according to the present drawings without any inventive effort.

FIG. 1 illustrates a perspective view of the present application;

FIG. 2 illustrates an exploded view of the present application;

FIG. 3 illustrates a perspective view of a press pin in the present application;

FIG. 4 illustrates a structural diagram on a mounting position of a spring in the present application;

FIG. 5 illustrates a mounting structure diagram on a silica gel pad in the present application;

FIG. 6 illustrates a mounting structure diagram on a guide rod in the present application;

FIG. 7 illustrates a perspective view on a mounting plate in the present application.

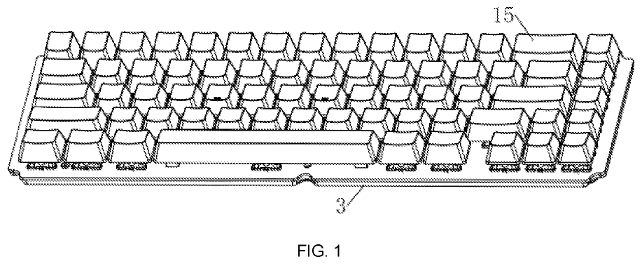

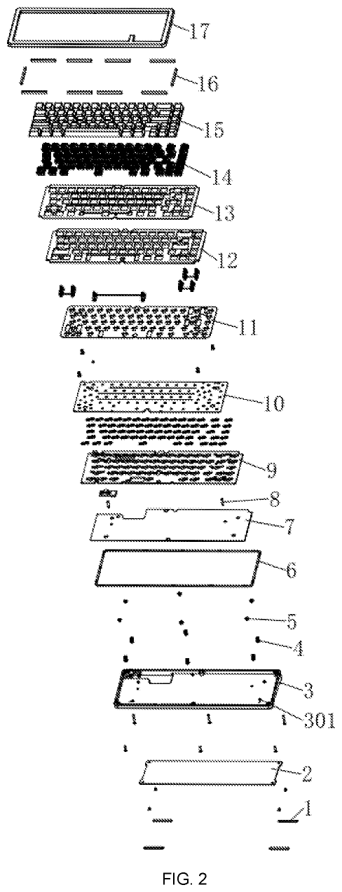

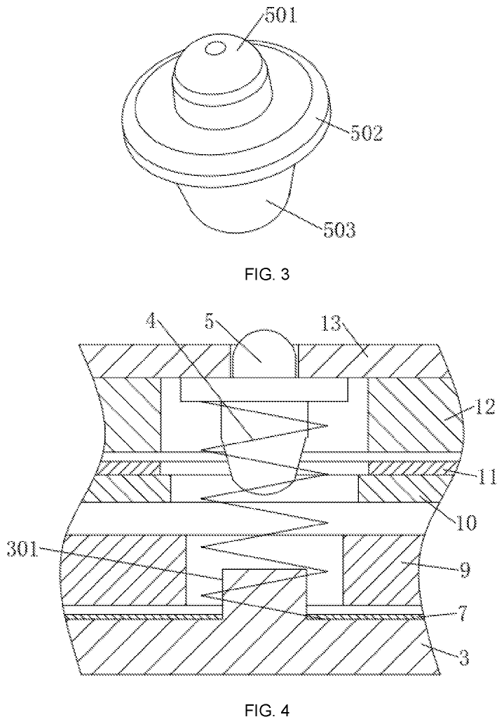

1. anti-skid strip; 2. backboard; 3. outer shell; 301. positioning standoffs; 4. spring; 5. press pin; 501. upper protrusion; 502. flat plate; 503. lower protrusion; 6. sealing gasket; 7. polyester film; 8. guiding rod; 9. rubber plate; 10. PCB; 11. partition plate; 12. positioning plate; 13. mounting plate; 14. switch; 15. key cap; 16. silica gel pad; 17. upper cover plate; 18. groove.

### DETAILED DESCRIPTION OF EMBODIMENTS

In order to make the purpose, technical solution and the advantages of the present application more clearly and more explicitly, further detailed descriptions of the present application are stated herein, referencing to the attached drawings and some embodiments of the present application. It should be understood that the detailed embodiments of the present application described here are used to explain the present application only, instead of limiting the present application.

As shown in the drawings, a spring mount keyboard comprises an outer shell 3, the outer shell 3 has a mounting plate 13 applied to mounting a switch 14 arranged inside at an upper position, and a plurality of positioning standoffs 301 arranged inside at a lower position thereof; wherein the positioning standoff 301 are distributed equally at a bottom wall position of the outer shell 3, the positioning standoff 301 has a spring 4 arranged on, the spring 4 has a press pin 5 connected to an upper position, the press pin 5 comprises a flat plate 502 arranged in a middle position, an upper protrusion 501 protrusion upwards is arranged above the flat plate 502, and a lower protrusion 503 protruding downwards is arranged below the flat plate 502; an upper part of the spring 4 is arranged sheathing an outside of the lower protrusion 503, and an end abuts against the lower surface of the flat plate 502; the upper protrusion 501 is positioned at a through hole arranged in a surface of the mounting plate 13. In such a way, the spring 4 is applied to replacing a conventional fixing structure, when the user presses a key, the mounting plate 13 will have a trend of moving downward, being able to make the stress on the switch 14 fixed on the mounting plate 13 consistent as much as possible, achieving an effect of supporting the mounting plate elastically.

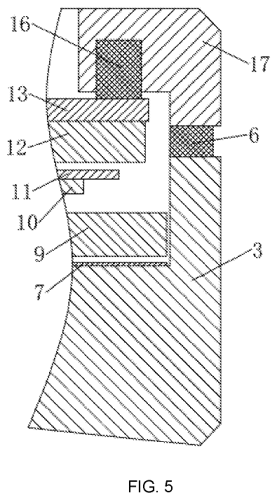

The outer shell 3 has an upper cover plate 17 with a hollowed-out structure arranged above, and a sealing gasket 6 is arranged at a joint between the outer shell 3 and the upper cover plate 17, shown as FIG. 5, the upper cover plate 17 and the outer shell 3 are connected through a plurality of bolts, and a contact part of the upper cover plate 17 and the outer shell 3 is sealed by the sealing gasket 6, to prevent any external dust or water from entering the keyboard.

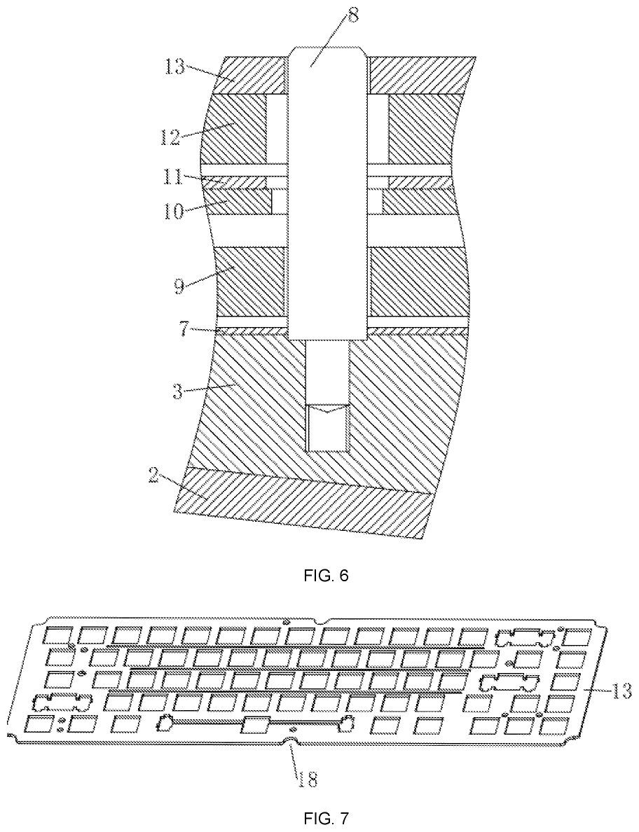

There is a gap arranged between the upper cover plate 17 and the mounting plate 13, and the gap has a plurality of silica gel pads 16 arranged. Shown as FIG. 6, the silica gel pads 16 are applied to avoiding the mounting plate 13 from contacting the upper cover plate 17, so as to prevent a problem of wearing caused by a mutual contact between the mounting plate 13 and the upper cover plate 17.

The switch 14 has a key cap 15 arranged above, each structure of the key cap 15 and the switch 14, as well as the connection structure of both belongs to conventional technical means in the prior art, and no more details are stated herein.

The mounting plate 13 has a positioning plate 12, a partition plate 11, and a PCB 10 arranged below sequentially, while the mounting plate 13, the positioning plate 12, the partition plate 11, and the PCB 10 are connected through a plurality of bolts. The mounting plate 13, the positioning plate 12, the partition plate 11, and the PCB 10 form an integrated keyboard module structure after being connected by the bolts and stay in a relatively stationary state all the time when in use.

The outer shell 3 has at least two guiding rods 8 arranged vertically installed at a bottom position, the guiding rods 8 connect to the outer shell 3 in a thread, and the guiding rods 8 are connected slidably with the mounting plate 13, the positioning plate 12, the partition plate 11, and the PCB 10. Further, the guiding rods 8 and the mounting plate 13 are connected slidably, that is mainly applied for the mounting plate 13 to having an effect of vertically lifting in a vertical direction, and avoiding a problem of inclination.

Grooves 18 are arranged in an edge position of the mounting plate 13, the positioning plate 12, and the PCB 10, shown as FIG. 7, the purpose of arranging the groove 18 is to achieve the effect of avoidance, to prevent the bolt connecting the upper cover plate 17 and the outer shell 3 from generating a mutual interference with the mounting plate 13, the positioning plate 12, and the PCB 10, and to ensure the pressure between the switch 14 and the PCB 10 is consistent.

The outer shell 3 has a polyester film 7 and a rubber plate 9 arranged sequentially above a bottom wall of the outer shell 3. The outer shell 3 has a back plate 2 installed on a bottom surface of the outer shell 3, and a plurality of anti-skid strips 1 is arranged at an edge position of the bottom surface of the outer shell 3.

It should be understood that, the descriptions of the present application are not limited to the examples listed above. Ordinary technical personnel in this field can improve or change the applications according to the above descriptions, all these improvements and transformations should belong to the scope of protection in the appended claims of the present application.

What is claimed is:

1. A spring mount keyboard, wherein comprising:
an outer shell (3);
a mounting plate (13) configured to mount a switch (14) arranged at an upper position inside the outer shell (3);
a plurality of positioning standoffs (301) arranged at a lower position inside the outer shell (3);
a spring (4) arranged on the positioning standoff (301);
a press pin (5) connected to an upper position of the spring (4);
the press pin (5) comprises a flat plate (502) arranged in a middle position of the press pin (5), an upper protrusion (501) protruding upwards arranged above the flat plate (502), and a lower protrusion (503) protruding downwards arranged below the flat plate (502);
an upper part of the spring (4) is arranged to sheath an outside of the lower protrusion (503), and an end of the spring (4) abuts against a lower surface of the flat plate (502);
the upper protrusion (501) is positioned at a through hole arranged in a surface of the mounting plate (13).

2. The spring mount keyboard according to claim 1, wherein an upper cover plate (17) with a hollowed-out structure is arranged above the outer shell (3), and a sealing gasket (6) is arranged at a joint between the outer shell (3) and the upper cover plate (17).

3. The spring mount keyboard according to claim 2, wherein a gap is arranged between the upper cover plate (17) and the mounting plate (13), and a plurality of silica gel pads (16) is arranged in the gap.

4. The spring mount keyboard according to claim 1, wherein a key cap (15) is arranged above the switch (14).

5. The spring mount keyboard according to claim 1, wherein a positioning plate (12), a partition plate (11), and a PCB (10) are arranged below the mounting plate (13) sequentially, the mounting plate (13), the positioning plate (12), the partition plate (11), and the PCB (10) are connected through a plurality of bolts.

6. The spring mount keyboard according to claim 5, wherein at least two guiding rods (8) are arranged vertically installed at a bottom position of the outer shell (3), the guiding rods (8) connects to the outer shell (3) in a thread, and the guiding rods (8) are connected slidably with the mounting plate (13), the positioning plate (12), the partition plate (11), and the PCB (10).

7. The spring mount keyboard according to claim 6, wherein a groove (18) is arranged in an edge position of the mounting plate (13), the positioning plate (12), and the PCB (10), respectively.

8. The spring mount keyboard according to claim 1, wherein a polyester film (7) and a rubber plate (9) are arranged sequentially above a bottom wall of the outer shell (3).

9. The spring mount keyboard according to claim 1, wherein a back plate (2) is installed on a bottom surface of the outer shell (3) has, and a plurality of anti-skid strips (1) is arranged at an edge position of the bottom surface of the outer shell (3).
